(19) United States
(12) Patent Application Publication
(10) Pub. No.: US 2017/0354567 A1
(43) Pub. Date: Dec. 14, 2017

(54) Massage and Scrub Device

(71) Applicants: William Howhong Shih, San Diego, CA (US); Stephen Howping Shih, San Diego, CA (US); Geoffrey Howting Shih, San Diego, CA (US)

(72) Inventors: William Howhong Shih, San Diego, CA (US); Stephen Howping Shih, San Diego, CA (US); Geoffrey Howting Shih, San Diego, CA (US)

(21) Appl. No.: 15/181,412

(22) Filed: Jun. 14, 2016

(51) Int. Cl. A61H 7/00; A61H 23/00; A61H 39/04; A61H 3/00

(52) U.S. Cl. CPC A61H 7/003; A61H 3/00; A61H 23/00; A61H 39/04; A61H 2201/0207

(57) ABSTRACT

Massage devices and back scratchers have had a long history in our civilization, which have led to the creation of many different deviations of the home use massage stick. One truth behind each and every massage stick design is that there has been an optimal distance between the massage object of the “head” of the massage device and the beginning of the curve of the “head” portion that has never been documented before. This patent can merge and create a massage tool and a cane into a single package. The massage stick can be a single entity or have a detachable shaft for the cane. The advantages of this patent allow manufacturers to design an effective massage stick and create a dual purpose massage stick that can act as a cane for the elderly to move around with, and allow easy access to the massage stick when they are seated.

### BACKGROUND OF THE INVENTION

In this modem age, the human populations' life-expectancy has been slowly increasing over the past few decades, meaning that there are more and more members of society growing older. This means that many individuals will be facing problems brought about by old age, such as bodily sores and the inability to support themselves on his or her own legs. In our modem civilization of growing conveniences, the elderly should have a way to not only support themselves, but also have a way to massage themselves.

By researching current massage tools and sticks, it has been discovered that there have been no mention of such a device on the market, nor any documentation of such an efficient device. To solve this problem, more research has been investigated to find out the optimal position for the massage object to be installed onto walking assisting stick. A distance from massage object to the point of inflection or the point where the stick changes concavity near the shaft are deemed important for portability and for functionality. The invention can not only be used as an everyday massage device, but it can also function as a walking stick for its users. The device design for the patent also include the ability to have multiple massage objects attached to the head of the device allowing it to be able to massage multiple areas of the body. Its ability to be made with all kind of material makes it suitable for not only for the elder, but also for any consumer.

### Description of the Prior Art

US 20070093736 A1: S-shaped back scratcher, scrubber and applicator; US D414295 S: Combination hand-held lotion applicator with back scratcher portion; U.S. Pat. No. 5,204,104 A: Physical therapy massage stick and process; U.S. Pat. No. 6,551,261 B1 ll: A Bamboo massage stick; US 20140039364 A1 Massage Device with Handle and Textured Object on Cord. All five prior patents describe massage device or similar of a type known in the prior art.

None of prior arts mentioned the distance between message object and the point of inflection or the point where the stick changes concavity near the shaft in their design.

### SUMMARY OF THE INVENTION

The present invention is developed not only help to be used on everyday massage device but it can design a functional massage walking stick for its users.

The present invention is developed according to average statistic of body human measurement and documentation of trigger points map, yet never been documented for making a massage device before. The present invention sets the measured distance between body trigger points and the curvature of human body as well as ease of use a massage device. A distant is set and measured from the furthest “massage object” and the “point of inflection” or the point where the stick changes concavity near the shaft.

The distance measures between 7 inches to 17 inches for this purpose. Out of this value, we deemed either insufficient to provide optimal massage purpose or too big to carry when is used as a practical walking device.

A further object of the invention is to provide massage instrument that can be simply manufactured either with same or different material to construct a walking stick with increased production efficiency.

### BRIEF DESCRIPTION OF THE DRAWINGS

FIG. 1 is a cross sectional view of the massage device of the first embodiment according to the invention; The simple illustration showed a curved massage head and the shaft portion for a walking stick when not attached.

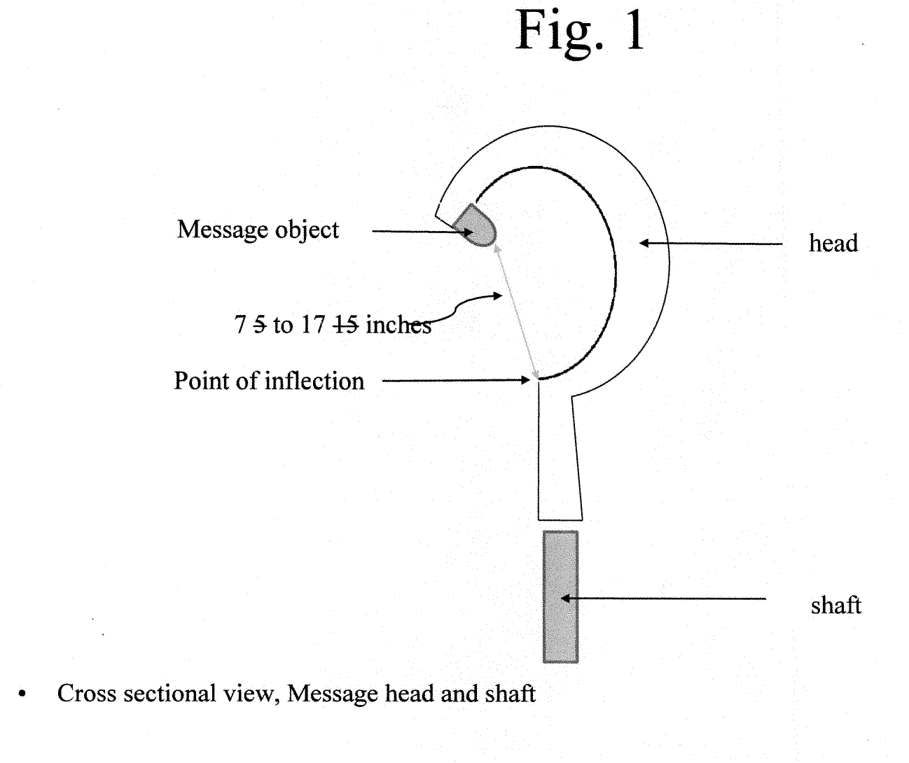

FIG. 2 is a cross sectional view of the device in example of variation but not limited to; such as when different material of the massage head and walking stick shaft were used.

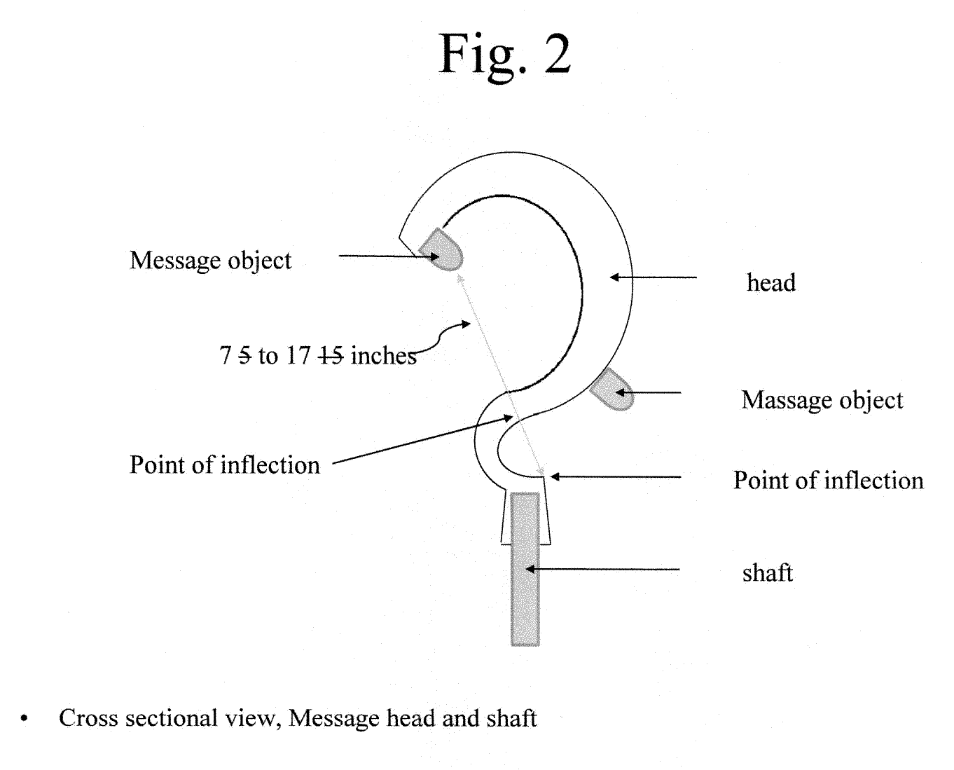

### DESCRIPTION OF THE INVENTION

Massage “object” in US 20140039364 A1 described a “textured object” as: “The other massage component, the textured object, is a compressible substance of conventional or unconventional shape. Using the handle and cord, the textured object can be placed and secured between the user and a planar surface of inclination between 0 and 90 degrees. Massage pressure can be modulated over the textured object with the user's body weight. The textured object can be sandwiched between the user and a variety of surfaces, including but not limited to, a wall or floor. Examples of other embodiments of the textured object are, but not limited to; a knobbed sphere, a ribbed cylinder, and a double ball.”

“The point of inflection”: Inflection points are where the function changes concavity. Since concave up corresponds to a positive second derivative and concave down corresponds to a negative second derivative, then when the function changes from concave up to concave down, (or visa versa) the second derivative must equal zero at those point. So the second derivative must equal zero to be an inflection point. (cited from http://clas.sa.ucsb.edu/staff/lee/inflection%20points.htm. Another definition for an “Inflection Point” is where a curve changes from Concave upward to Concave downward (or vice versa). (cited from http://www.mathsisfun.com/calculus/inflection-points.html). f′(x)=3x². Then the second derivative is: f″(x)=6x. Now set the second derivative equal to zero and solve for “x” to find possible inflection points. Other definition for “The point of inflection”: Inflection points are where the function changes concavity. Since concave up corresponds to a positive second derivative and concave down corresponds to a negative second derivative, then when the function changes from concave up to concave down (or vise versa) the second derivative must equal zero at that point. So the second derivative must equal zero to be an inflection point. (cited from http://clas.sa.ucsb.edu/staffilee/inflection%20points.htm

Usually to make an effective tool for massage will required one or more curves of the massage tool, the least one curve is on massage head where attached massage “object” to give acupressure point pressure in foci and the other curve might be built on a handle for easy grabbing of the tool, and shape will look like “question mark” (“?”), or a sickle-curve shape. This is observed true especially inspect from a profile view yet not documented in any paper before.

Due to the fact that at least one curve present and more curves that must meet somewhere in between. No matter what the curve looks like, there is a point of inflection between two curves or at end of one curve and can be measured by current mathematic method.

By observing the human anatomy, the average depth of a modern human chest is 9½ inches. (http://www.fas.harvard.edu/˜loebinfo/loebinfo/Proportions/humanfigure.html)

By observing the human anatomy, the average width of a modern human spine is in about 1 inch. (http://www.ncbi.nlm.nih.gov/pmc/articles/PMC2900026/)

Lots of massage acupressure points or call “trigger points” are located on the side of the spine was documented in ancient Chinese medicine books. (http://acupressurepointsguide.com/most-important-acupressure-points-for-back-pain/)

Considering the above excellent documentations and facts, the measurement of distance between massage object and curve of inflection is established to be used in current invention.

Current invention only considers 7 to 17 inches is optimal distance between the furthest “massage object” and the point of inflection or the point where the stick changes concavity near the shaft.

A massage device head can then attached the shaft or extended the lower handle head body as a stick and used as a walking assisting stick.

It will be appreciated that various modifications of the present invention may be undertaken by those skilled in the art without departing from the spirit and scope hereof.

What is claimed is:

1. A massage device is comprised of a head and a shaft; the head is shaped like a curved “question mark” or a sickle-curve shape for the walking stick handle and has the “massage object” attached to the handle. The distance between the furthest “massage object” and the “point of inflection” or the point where the stick changes concavity near the shaft measures between 7 inches to 17 inches.

2. A massage device is made of a durable material, such as wood, polyethylene Glycol plastic, or metal as set forth claimed in claim 1.

3. A massage device as set forth in claim 2, wherein the massage portion and the shaft are coupled by a gemstone.

4. A massage device as set forth in claim 2, wherein the massage portion and the shaft are coupled by a mineral rock.

5. A massage device as set forth in claim 2, wherein the massage portion and the shaft are coupled by a magnet.

6. A massage device as set forth in claim 2, wherein the massage portion and the shaft are coupled by a heating device.

7. A massage device as set forth in claim 2, wherein the massage portion and the shaft are coupled by a vibrating device.

8. A massage device as set forth in claim 1, wherein the shaped massage object is either ball shape, egg shape, cone or multi-head spherical shape.

9. A massage device as set forth in claim 1, wherein is used as a walking assisting stick.

10. A massage device as set forth in claim 1, wherein is used as a scrub device.
